(19) United States
(12) Patent Application Publication
(10) Pub. No.: US 2009/0305220 A1
(43) Pub. Date: Dec. 10, 2009

(54) Gas Monitor Training System

(76) Inventors: John B. Holtan, Bismark, ND (US); Michael A. Holman, Mandan, ND (US)

Correspondence Address: NEUSTEL LAW OFFICES, LTD., 2534 SOUTH UNIVERSITY DRIVE, SUITE 4, FARGO, ND, 58103, US

(21) Appl. No.: 12/136,434

(22) Filed: Jun. 10, 2008

(51) Int. Cl. G09B 19/24; G09B 19/00

(52) U.S. Cl. 434/365

(57) ABSTRACT

A gas monitor training system for efficiently providing interactive and simulated training for individuals who are to utilize a portable gas monitor. The gas monitor training system generally includes an instructor computer, a database connected to the instructor computer, wherein the database includes information to be edited by the instructor computer and at least one training device, wherein the at least one training device receives the information of the database and wherein the training device transmits the information to a student. The information is comprised of messages commonly displayed upon a gas detection monitor and is also generally communicated between the training device and the portable computer via the network.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to gas monitors and more specifically it relates to a gas monitor training system for efficiently providing interactive and simulated training for individuals who are to utilize a portable gas monitor.

2. Description of the Related Art

Any discussion of the prior art throughout the specification should in no way be considered as an admission that such prior art is widely known or forms part of common general knowledge in the field.

Gas monitors have been in use for years. Typically, gas monitors are manufactured in both portable and stationary configurations. Gas monitors comprised of portable configurations are generally taken out into the field by an individual when the individual is checking the percentages of certain gases in the local environment. Individuals may check the percentage amounts of the gases for various reasons, such as but not limited to a standard routine and/or if the individual is working in that particular area.

The individual utilizing the portable gas monitor must generally be efficiently trained prior to use of the gas monitor. The importance of the thoroughness of the training is obvious when considering the inherent dangers that the gases pose to the individual and the need for the individual to effectively recognize when such gases are present.

Generally, training involves classroom lectures, video tapes and reading various manuals or books. All of these training materials may provide a basic understanding of the functions of the portable gas monitor; however these materials generally do not provide the hands on training that may be necessary to utilize the portable gas monitor effectively. Because of the general lack of efficiency and practicality in the prior art there is the need for a new and improved gas monitor training system for efficiently providing interactive and simulated training for individuals who are to utilize a portable gas monitor.

### BRIEF SUMMARY OF THE INVENTION

The general purpose of the present invention is to provide a gas monitor training system that has many of the advantages of the gas monitors mentioned heretofore. The invention generally relates to a gas monitor which includes an instructor computer, a database connected to the instructor computer, wherein the database includes information to be edited by the instructor computer and at least one training device, wherein the at least one training device receives the information of the database and wherein the training device transmits the information to a student. The information is comprised of messages commonly displayed upon a gas detection monitor and is also generally communicated between the training device and the portable computer via a display.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a gas monitor training system for efficiently providing interactive and simulated training for individuals who are to utilize a portable gas monitor.

Another object is to provide a gas monitor training system that provides a good understanding of how to effectively utilize a portable gas monitor in real life situations.

An additional object is to provide a gas monitor training system that may utilize various electronic devices (i.e. PDA, PSP, instructor computer, cell phone, etc.) as a substitute portable gas monitor.

A further object is to provide a gas monitor training system that utilizes a database to allow communication between the instructor and the student during training sessions.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an illustration of the communication process of the present invention.

FIG. 2 is a flow diagram of the present invention.

### DETAILED DESCRIPTION OF THE INVENTION

A. Overview

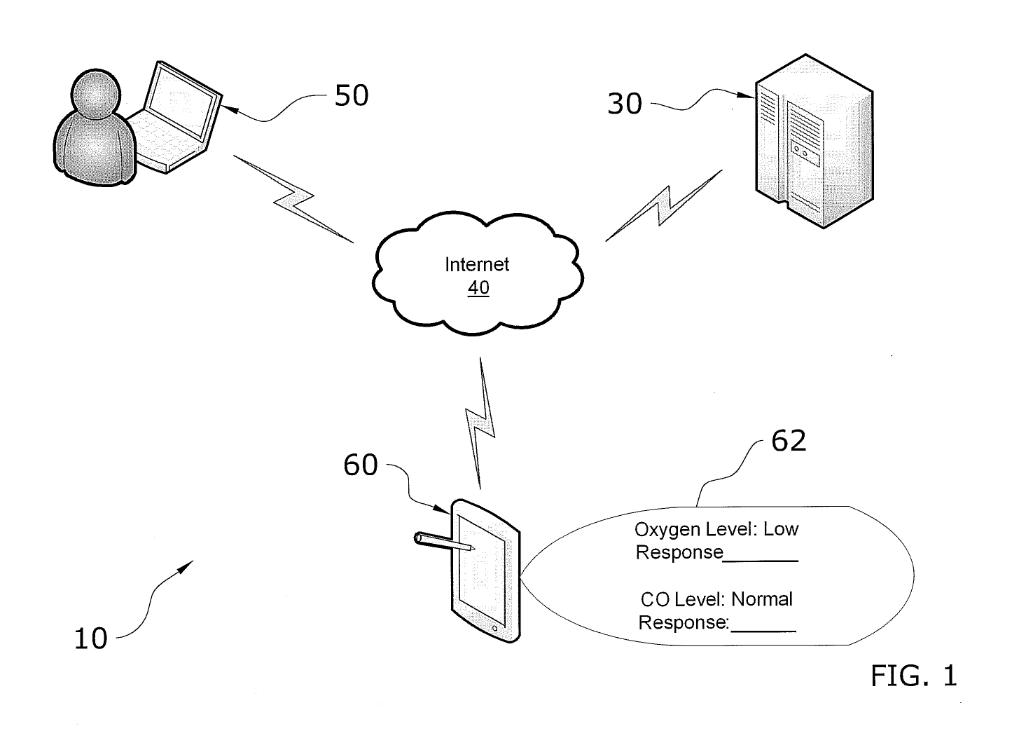

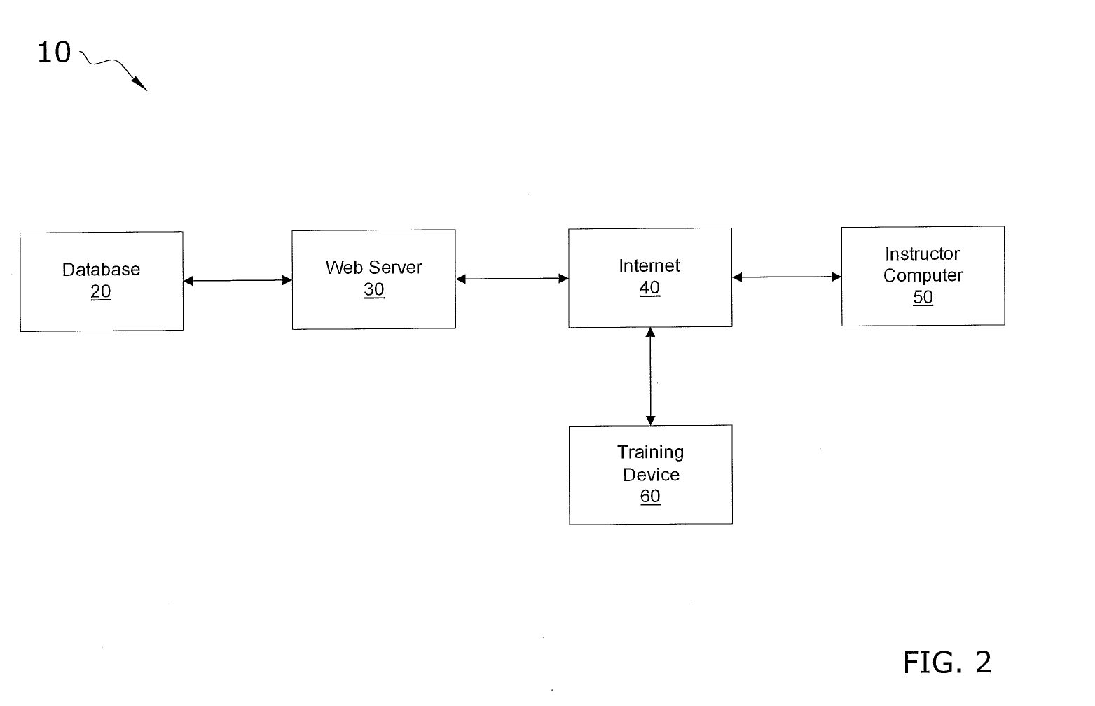

Turning now descriptively to the drawings, in which similar reference characters denote similar elements throughout the several views, FIGS. 1 through 2 illustrate a gas monitor training system 10, which comprises an instructor computer 50, a database 20 connected to the instructor computer 50, wherein the database 20 includes information to be edited by the instructor computer 50 and at least one training device 60, wherein the training device 60 receives the information of the database 20 and wherein the training device 60 transmits the information to a student. The information is comprised of messages 62 commonly displayed upon a gas detection monitor and is also generally communicated between the training device 60 and the instructor computer 50 via the computer network 40.

B. Database

The database 20 includes information relating to functions and messages 62 utilized on a standard portable gas monitor common in the art. The information within the database 20 is also preferably updatable, wherein an instructor may update the information within the database 20 from a remote computer (i.e. instructor computer 50) or local computer (i.e. server computer 30). The information may further be comprised of warnings, audible alerts, procedures or any information utilized by a standard portable gas monitor.

The database 20 may be comprised of various formats all which allow communication between the server computer 30 and the training device 60 and also the instructor computer 50 and the server computer 30. In the preferred embodiment, the database 20 is preferably comprised of a format to be displayed, such as but not limited to HTML. It is appreciated that the database 20 may be stored upon the server computer 30 or the instructor computer 50 utilized by the instructor. In the preferred embodiment of the present invention, the database 20 is stored upon the server computer 30.

It is appreciated that in the description of the present invention, the term remote computer generally refers to any instructor computer 50 utilized by an instructor. The term local computer in the description of the present invention generally refers to the server computer 30

C. Server Computer

The server computer 30 allows communication between the database 20 and the computer network 40 as illustrated in FIGS. 1 and 2. The server computer 30 is preferably comprised of a database server configuration, wherein the server computer 30 is able to send and receive information via the database 40. It is appreciated that the information may relate to information from the database 20, from the instructor computer 50 or from the training device 60.

The database 20 is also preferably stored within the server computer 30. The server computer 30 may however be comprised of a software program and integral with the instructor computer 50, wherein the database 20 would likewise be stored within the instructor computer 50.

D. Computer Network

The computer network 40 receives information from the database 20 via the server computer 30 and transmits the information to the instructor computer 50 and the training device 60 as illustrated in FIGS. 1 and 2. Likewise, the computer network 40 receives feedback information from the instructor computer 50 and the training device 60 to update and send to the database 20.

The computer network 40 may be comprised of various configurations, such as but not limited to a series of computers interconnected through the server computer 30 and an intranet. In the preferred embodiment of the present invention, the computer network 40 is comprised of the database, wherein the database is accessible via various programs, such as but not limited to INTERNET EXPLORER and NETSCAPE.

E. Instructor Computer

The instructor computer 50 is utilized by the instructor, wherein the instructor selectively updates the database 20 via the computer network 40 and the server computer 30. The instructor computer 50 may be comprised of various configurations such as a notebook computer or a desktop computer as illustrated in FIG. 1. The instructor computer 50 is also preferably connected to the network 40 and able to selectively edit the page holding the information from the database 20. It is also appreciated that the instructor computer 50 may be comprised of various configurations rather than a standard computer, such as but not limited to a cell phone or a PDA (personal digital assistant).

The instructor computer 50 is further preferably wirelessly connected to the network 40. The instructor computer 50 is preferably controlled by an instructor, trainer or teacher; however it is appreciated that the instructor computer 50 may be pre-programmed to run independently, wherein the instructor computer 50 would update the database 20 at pre-determined times. It is also appreciated that the present invention may include multiple instructor computers 50 to simultaneously send various messages 62 to multiple training devices 60 and thus multiple students.

F. Training Device

The training device 60 serves the function of mimicking a portable gas monitor common in the art, wherein the training device 60 depicts what a real portable gas monitor would display when utilized to detect or sample harmful gases. The training device 60 mimics the real portable gas monitor by receiving the information from the database 20 via the network 40 as illustrated in FIGS. 1 and 2. The training device 60 may be comprised of various structures some of which resemble a standard portable common gas monitor and some of which do not resemble a standard portable gas monitor. The information (i.e. messages 62) transmitted on the training device 60 however is substantially similar to the information commonly displayed on a portable gas monitor.

The information may relate to warnings of gas (i.e. carbon monoxide, carbon dioxide, etc.) percentage levels, changes in gas (i.e. oxygen, carbon monoxide, etc.) percentage levels or various other messages 62 commonly displayed on a standard portable gas monitor common in the art. The information may be further be transmitted in the form of a visual message 62 on a screen, an audible sound or a vibratory mechanism.

The training device 60 is able to receive messages 62 from the computer network 40 and further preferably able to communicate with the computer network 40. In the preferred embodiment of the present invention, the training device 60 is able to communicate with the database, wherein the computer network 40 is comprised of the network. The training device 60 is further preferably able to communicate wirelessly with the internet 40 so as to allow the student to utilize the training device 60 in real world scenarios.

The training device 60 may be comprised of various electronic devices. Some of the electronic devices include a PDA (personal digital assistant), a PSP, a training computer or a cell phone. It is appreciated that the training device 60 may be comprised of various other electronic devices all which are able to receive messages 62 and preferably communicate with the computer network 40. The training device 60 is also preferably comprised of a hand-held device. In the context of the previous description, the training computer may be comprised of any notebook computer or desktop computer; however it is appreciated that the training computer is separate from the instructor computer 50 utilized by the instructor, teacher or monitoring individual.

It is also appreciated that the present invention may include multiple training devices 60, wherein multiple students are being trained at the same time. The multiple training devices 60 would each preferably be independently connected to the computer network 40 to send and receive messages 62. The messages 62 transmitted to the student by the training devices may be comprised of simply a image or text viewable upon the training device 60.

G. In Use

In use, the server 30, the instructor computer 50 and the training devices 60 are first connected to the network 40 and the software is started. A real-life scenario is also preferably setup, wherein the student holding the training device 60 is sent into the room/area comprised of the real-life scenario. It is appreciated that the real-life scenario does not actually include any gases that may harm the student, wherein the real-life scenario may be any room/area in which the student is to train or be tested within.

As the student enters the area/room including the real-life scenario the instructor preferably logs onto the database holding the information of the database 20 and changes a value or inputs new information (i.e. change in oxygen level) upon the database 20. The change will subsequently be sent via the network 40 to the training device 60, wherein the change will appear as a message 62 (i.e. Oxygen levels are low!) upon the training device 60.

The student must now react or respond to the message 62 accordingly as they would do in a real-life situation (i.e. insert health related text on the display via the training device 60). The instructor may subsequently comment on the response by the student upon the display via the instructor computer 50 and/or input various other values/changes in information upon the database 20 to be subsequently sent to the training devices 60 via the network 40.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A gas monitor training system, comprising:
an instructor computer;
a database in communication with said instructor computer, wherein said database includes information to be edited by said instructor computer;
wherein said information is comprised of messages and values commonly displayed upon a gas detection monitor; and
at least one training device, wherein said at least one training device receives said information.

2. The gas monitor training system of claim 1, wherein said information received by said at least one training device is comprised of a visual message configuration.

3. The gas monitor training system of claim 1, wherein said information received by said at least one training device is comprised of an audible message configuration and/or a vibration alarm.

4. The gas monitor training system of claim 1, wherein said at least one training device communicates with said instructor computer.

5. The gas monitor training system of claim 1, wherein said at least one training device wirelessly communicates with said instructor computer.

6. The gas monitor training system of claim 1, wherein said information of said database is communicated with said at least one training device via a computer network.

7. The gas monitor training system of claim 6, wherein said computer network is comprised of computers, routers, PDA's.

8. The gas monitor training system of claim 6, including a server computer to communicate said information of said database with said instructor computer via said computer network.

9. The gas monitor training system of claim 8, wherein said server computer is comprised of a network server and computer network is comprised of is comprised of computers, routers, PDA's.

10. The gas monitor training system of claim 9, wherein said information of said database is displayed upon said network via a display.

11. The gas monitor training system of claim 10, wherein said instructor computer edits said information of said database via said instructor panel.

12. The gas monitor training system of claim 11, wherein said at least one training device is wirelessly connected to said network.

13. The gas monitor training system of claim 11, wherein said at least one training device communicates with said instructor computer via said network.

14. The gas monitor training system of claim 1, wherein said at least one training device is comprised of a plurality of training devices.

15. The gas monitor training system of claim 1, wherein said at least one training device is comprised of a cell phone.

16. The gas monitor training system of claim 1, wherein said at least one training device is comprised of a personal digital assistant.

17. The method of the gas monitor training system of claim 1, wherein said at least one training device is comprised of a hand held configuration.

18. A gas monitor training system, comprising:
a server connected to the network;
a database in communication with said network via said server, wherein said database includes information comprised of messages and values commonly displayed upon a gas detection monitor;
wherein said information of said database is displayed upon said network via a splay page;
an instructor computer in communication with said network, wherein said instructor computer edits said information of said database via said instructor panel; and
at least one training device in communication with said network, wherein said at least one training device receives said information of said database via said network and wherein said at least one training device transmits said information.

19. A method of a gas monitor training system, comprising:
providing a database, wherein said database includes information commonly displayed upon a gas detection monitor relating to gas levels;
providing a server connected to a network transmitting said information of said database to said network via said server;
displaying said information of said database upon said network in a display page format;
providing an instructor computer, wherein said instructor computer is connected to said network;
providing a training device, wherein said training device is wirelessly connected to said network;
editing said database via said instructor computer; and
communicating said data to a student utilizing said training device.

20. The method of the gas monitor training system of claim 1, wherein said training device is comprised of a hand-held configuration.
